(19) United States
(12) Patent Application Publication
(10) Pub. No.: US 2020/0053143 A1
(43) Pub. Date: Feb. 13, 2020

(54) SYSTEM FOR PRIORITIZING COMPUTER APPLICATIONS IMPLEMENTED BY A GROUP OF USERS

(71) Applicant: ORANGE, Paris (FR)

(72) Inventors: Eric Paillet, Chatillon Cedex (FR); Stephane Tuffin, Chatillon Cedex (FR)

(21) Appl. No.: 16/345,873

(22) PCT Filed: Oct. 26, 2017
(86) PCT No.: PCT/FR2017/052961

§ 371 Date: Apr. 29, 2019

(30) Foreign Application Priority Data
Oct. 28, 2016 (FR) 1660488

(51) Int. Cl. H04L 29/06; H04L 12/725; H04L 12/859

(52) U.S. Cl. CPC H04L 65/80; H04L 47/2475; H04L 45/308

(57) ABSTRACT

A multimedia flow marking device. The device is configured to perform acts including: after receiving a multimedia flow generated by a computer application executed by the device, identifying the computer application by using an application identifier; consulting a database indicating which computer applications should be subjected to a marking and what the computer application/marking value pairs are; and packaging the multimedia flow in the form of data packets marked as a result. Application for web browsers for personal computers, and operating systems for mobile terminals or connected objects.

### CROSS-REFERENCE TO RELATED APPLICATIONS

This Application is a Section 371 National Stage Application of International Application No. PCT/FR2017/052961, filed Oct. 26, 2017, the content of which is incorporated herein by reference in its entirety, and published as WO 2018/078293 on May 3, 2018, not in English.

### FIELD OF THE DISCLOSURE

The present invention relates to the field of telecommunications. More particularly, the present invention relates to the group policies within a given entity, such as an enterprise or a public administration.

### BACKGROUND OF THE DISCLOSURE

Within the framework of the use of Web applications and of mobile applications by a group of users, so-called group policies, or enterprise policies, allow an administrator to configure Web browsers on personal computers (PC), as well as the operating systems of mobile terminals, for the needs of an entity: the administrator can thus, for example, designate a proxy server to be used compulsorily, deactivate functions of a Web browser (such as synchronization with an external service in respect of bookmarks and passwords), or impose security rules for the use of mobile equipment (such as the locking of the mobile item after an activity time, or the compulsory use of a PIN code to unlock the mobile item).

The invention relates, still more particularly, to computer applications. By “computer application” (for the sake of brevity, we shall sometimes say simply “application” hereinbelow) is meant, within the framework of the present invention, any Web or mobile service executing on a user terminal, such as a PC, an intelligent telephone (or “smartphone” in English) or a connected object, and real-time communication services in particular. It is recalled in this regard that “connected objects” form part of the “Internet of Things”, which has been defined by the International Telecommunication Union (cf. General presentation of the Internet of Things (ITU-T Y.2060), June 2012, § 3.2.2 International definition) as being a “worldwide infrastructure for the information society, which affords the possibility of evolved services through the interconnecting of (physical or virtual) objects by virtue of existing or evolving interoperable information and communication technologies”.

The computer applications concerned may for example be Skype, Whatsapp, Viber, Messenger, or Youtube, but also solutions in respect of voice over IP (Internet Protocol) communication, videoconferencing, electronic mail, instant messaging, social networks, blogs, Web services in general and notably those which generate multimedia streams that are potentially significant in terms of bitrate such as downloads.

The multimedia streams negotiated when establishing or modifying a multimedia communication session are liable to be processed in a hierarchized manner by a control entity of the network. Accordingly, document RFC 4412 of the IETF (Internet Engineering Task Force), entitled “Communications Resource Priority for the Session Initiation Protocol (SIP)” defines a header field in a request in accordance with the SIP protocol (Session Initiation Protocol) called “Resource-Priority”, and which makes it possible to ask for priority access to certain network resources (such as network gateways, routers, or SIP proxy servers). The “Resource-Priority” SIP header field is filled in with one or more domain names. When a control entity of the network receives an SIP message comprising the “Resource-Priority” SIP header field, it verifies that the message is valid, and identifies the services associated with the domain names of the “Resource-Priority” SIP header field. When the network resources are saturated, this control entity can preempt the other ongoing communication sessions that are not associated with an identified domain name, or insert the SIP request comprising the “Resource-Priority” header field into a queue of requests to be processed by priority. The mechanism described in document RFC 4412 thus makes it possible to process by priority a communication session, and indirectly all of the media streams associated with this session.

U.S. Pat. No. 7,843,843 discloses an arrangement whose objective is to hierarchize certain data streams with respect to others. Accordingly, a device situated in a router or a gateway, and participating in the management of the traffic transmitted to a differentiated services network handling one or more classes of service, performs a classification of the traffic in terms of applications on the basis, for example, of the network protocol used (TCP, HTTP, and so on and so forth), and then identifies the service concerned in this traffic by relying, inter alia, on this classification. More precisely, this device comprises:

a processor of packets which is able to detect data streams in the network traffic traveling through a communication path, said data streams each comprising at least one packet;

a traffic classification engine making it possible to identify one or more applications in the data streams traveling through the apparatus;

a module for controlling performance of the network able to control the performance of the differentiated services network relating to one or more classes of services handled by the differentiated services network; and

a service class selector able to
calculate, for at least one of the applications, capability values for the service class or classes on the basis of minimum respective acceptable performance parameters associated with the corresponding applications and of the controlled performance of the service class or classes handled by the differentiated services network, and
select a service class from among one or more service classes for a given data stream on the basis of the application identified and of the comparison between the capability values for each of the service classes corresponding to the application identified.

This device is able to mark the packets of the data streams on the basis of the identified network applications and of the selected service classes, and thereafter to transmit the data packets to the differentiated services network.

The arrangement according to U.S. Pat. No. 7,843,843 is however ineffective: indeed, once they have been sent by a terminal, the data streams are very often encrypted, and then multiplexed with other streams which may potentially use the same network protocol (TCP, HTTP, and so on and so forth); under these conditions, the classification and identification device described in this document will be unable to determine from which application this or that data packet originates.

### SUMMARY

The present invention therefore relates, according to a first aspect, to a multimedia stream marking device. Said device comprises means for:

subsequent to the receipt of a multimedia stream generated by a computer application executed by said device, identifying said computer application by means of an application identifier,

consulting a database indicating which computer applications are the ones that must form the subject of a marking and which are the computer application/marking value pairs, and

conditioning the multimedia stream in the form of data packets marked accordingly.

Thus, according to the invention, the identification of a multimedia stream is done as close as possible to the application generating this stream, namely at the level of the device (such as a browser or an operator system) which executes the application. Hence, the data packets are already marked when they exit this device, and therefore the terminal hosting this device. According to U.S. Pat. No. 7,843,843 mentioned hereinabove, on the contrary, the identification of the service concerned and the marking of the stream are performed in an external device situated downstream of the terminals in which the data streams are generated.

By virtue of these provisions, the administrator of an entity such as an enterprise or a public administration will be able to hierarchize certain applications with respect to other competing applications, by allotting different levels of Quality of Service (QoS) to these applications, in particular as regards the interactive real-time streams, such as audio communications and videoconferences, generated by these applications and exchanged within the entity. The administrator might, for example, decide to allot the highest QoS level to the WebRTC application allowing conference bridges within the group, and then a lesser QoS level to the instant messaging application, and finally decide that the other communication services (such as Skype) will share the remainder of the bandwidth available at the level of the entity's routers. It might also, for example, guarantee the entity's employees a certain image refresh rate, or a certain real-time video resolution, even in the presence of competing traffic.

The streams generated by the entity's terminals will then advantageously form, as they pass through this entity's routers, the subject of a differentiated processing, on the basis of said marking. This differentiated processing might for example be carried out, in a manner known per se, by means of a marking and of an arrangement of the routers in accordance with the DiffSery standard, described succinctly hereinbelow. It is recalled that, generally, “traffic management” (or “Queuing Discipline”), such as “Hierarchical Token Bucket” (HTB), FQ_CodeI, “Proportional Integral controller Enhanced” (PIE) or “Stochastic Fairness Queuing” (SFQ), consists, for a network administrator, in configuring the allocation of network resources such as buffer memory and transmission capacity as a function of predetermined criteria.

It will be noted that the invention applies preferentially to the routers situated in the same administrative domain as the terminals which perform the marking according to the invention, since network administrators/operators do not generally trust the markings performed by another administrative domain; the invention is therefore aimed at notably (but not exclusively), for a given entity, its local network (“Local Area Network”, or LAN in English), its secure tunnels (“Virtual Private Network”, or VPN in English), and its Internet accesses.

The invention also relates, according to a second aspect, to a system for hierarchizing the computer applications which are implemented by a group of users. Said system is noteworthy in that it comprises:

a multimedia stream marking device such as described succinctly hereinabove, and

at least one router able to take said marking into account so as to apply to the multimedia streams traveling through said router service levels differentiated as a function of the computer applications generating these multimedia streams.

The advantages offered by this system are essentially the same as those offered by the multimedia stream marking device which is described succinctly hereinabove.

It will be noted that it is possible to embody this device in the context of software instructions and/or in the context of electronic circuits.

This is why the invention is also aimed at a computer program downloadable from a communication network and/or stored on a medium readable by computer and/or executable by a microprocessor. This computer program is noteworthy in that it comprises instructions for managing the operation of the multimedia stream marking device which is set forth succinctly hereinabove, when it is executed on a computer.

The advantages offered by this computer program are essentially the same as those offered by said device.

The invention also relates, according to a third aspect, to a multimedia stream marking method. Said method comprises the following steps:
reception of a multimedia stream generated by a computer application executed by a multimedia stream marking device,

identification of the computer application which has generated said multimedia stream by means of an application identifier,

consultation of a database indicating which applications are the ones that must form the subject of a marking, and which are the computer application/marking value pairs, and

conditioning of the multimedia stream by said multimedia stream marking device in the form of data packets marked accordingly.

The advantages offered by this marking method are essentially the same as those offered by said device.

### BRIEF DESCRIPTION OF THE DRAWINGS

Other aspects and advantages of the invention will become apparent on reading the description detailed hereinbelow of particular embodiments which are given by way of nonlimiting examples. The description refers to the figures which accompany it and in which:

FIG. 1 represents a network architecture able to implement the invention,

FIG. 2a represents, as output of a Web browser, a list of interactive real-time streams generated by an unprioritized application, and

FIG. 2b represents, as output of a Web browser, a list of interactive real-time streams generated by a prioritized application.

### DETAILED DESCRIPTION OF ILLUSTRATIVE EMBODIMENTS

We shall recall, to begin, what is entailed by conventional DSCP marking.

“Differentiated Services” (DiffServ) (cf. https://en.wikipedia.org/wiki/Differentiated_services) is the term for a computer network architecture described in December 1998 by the IETF in document RFC 2474, and which defines a simple and evolvable mechanism for classifying and managing network traffic and for providing an appropriate Quality of Service on IP networks. The DiffSery mechanism may, for example, be used to provide low latency to critical network traffic, such as Voice or continuous media (“streaming” in English), while providing a simple “best effort” service to non-critical services such as Web traffic or file transfers.

For data packet classification purposes, the DiffSery mechanism uses a “differentiated services code value” (“Differentiated Services Code Point”, or DSCP in English) of 6 bits within the 8-bit “Differentiated Services” (DS) field contained in the header of the IP packets. The DiffServ mechanism operates in accordance with the principle of traffic classification consisting in placing the data packets in a certain number of traffic classes, rather than differentiating the traffic on the basis of the characteristics specific to each stream. Each router of the network is configured in such a way as to process the traffic in a differentiated manner as a function of its class; this processing consists for example in transferring the packets of a class by priority with respect to those of other traffic classes, in guaranteeing a minimum bitrate for a traffic class, or in placing the packets of a certain class in an active queue whose length is managed (by deleting packets) in such a way as not to lastingly exceed a transit target lag when traversing the router.

It will be noted that:

1) in the prior art , the DSCP marking can be performed at the source by an application installed on a terminal dedicated to this application; on the contrary, the present invention relates to multimedia streams (for example arising from a microphone or camera) received by a device such as a Web browser or an operating system, this device then implementing a conditioning of these multimedia streams into the form of data packets, said data packets including a specific marking; moreover, the devices according to the invention perform this marking, generally, so as to hierarchize the multimedia streams arising from a plurality of applications;

2) a developer could in principle code a Web application in such a way that the streams are marked with a certain DSCP value (see for example https://groups.google.com/forum/?fromgroups#!topic/discuss-webrtc/96TyhNJkYqs), but in practice this possibility is not used since the developer of the application ought to interrogate the administrator of each enterprise to which it provides such an application in order to determine whether the streams of their application, for this enterprise, should be marked with this or that DSCP value; this would obviously pose a problem of scaling for application developers; moreover, this would compel administrators to replace their applications subsequent to each modification of the enterprise's traffic policy.

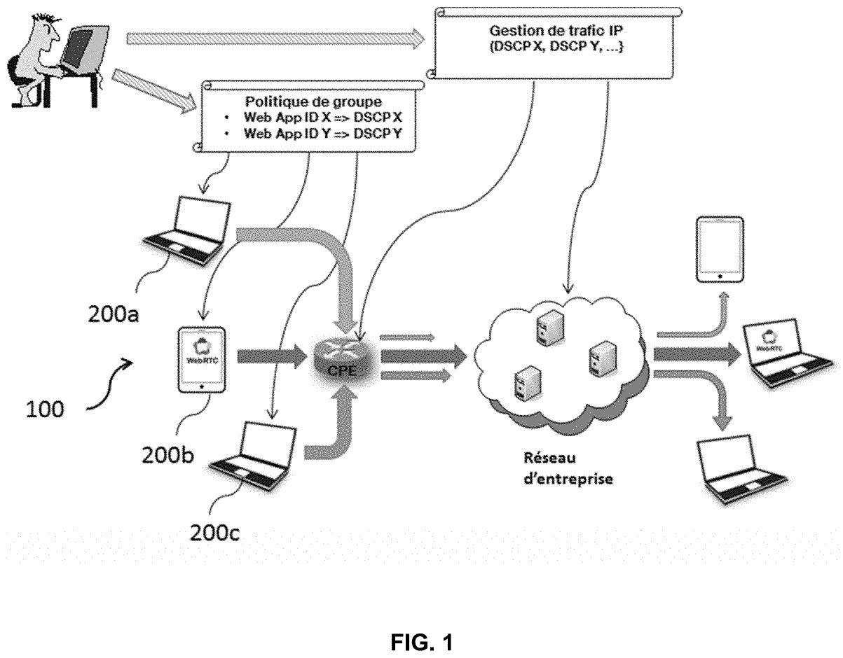

A network architecture able to implement the invention will now be described with reference to FIG. 1,.

FIG. 1 represents an enterprise 100. A group of employees of this enterprise uses terminals such as personal computers, mobile terminals or connected objects; these terminals are designated by 200a, 200b, 200c, . . . , in FIG. 1. The streams generated by these terminals pass through routers of an LAN network or of a wide area network (WAN) of the enterprise. A residential gateway (“Customer Premises Equipment” in English), denoted CPE in FIG. 1, serves as interface between said terminals 200a, 200b, 200c, . . . , and said network of the enterprise.

An embodiment of the invention will now be described.

The enterprise 100 has determined a certain enterprise policy consisting in associating respective QoS levels with certain respective computer applications (denoted Web App ID X, Web App ID Y, and so on and so forth, in FIG. 1) used by the terminals of said group of employees.

This association according to the invention is, consequently, integrated by an administrator of the network of the enterprise into a tool describing the enterprise policy, for example the directory administration tool “Active Directory” called GPME (Group Policies Management Editor) in a Windows environment.

This association according to the invention is then recorded in one or more database(s) accessible to the computer devices embedded in the terminals 200a, 200b, 200c, . . . , of said group, such as the Web browsers of personal computers and/or the operating systems of mobile terminals or of connected objects.

Furthermore, these devices comprise means for marking the data packets sent by these terminals. It is for example possible, accordingly, to use a marking of DSCP type such as described hereinabove.

Each time that such a device receives a multimedia stream generated by an application executed by this device, it implements the following steps (it will be noted that there generally exists a plurality of applications executed simultaneously by this device).

According to a first step, the device identifies the application which has generated said multimedia stream by means of an application identifier, such as, in the case of the enterprise's Web browsers, the URI (Uniform Resource Identifier) of the application, or, in the case of the operating systems of mobile terminals, a conventional downloadable application identifier, for example the denomination of a “java package” (in the format net.name-of-the-developer .name-of-the-package”) or the “Bundle ID” (in the format com.name-of-the-user.name-of-the-application) of an application under Apple's IOS. For example, a browser can thus determine that a given stream, in HTTPS format, has been generated by the Whatsapp application, and that another given stream, likewise in HTTPS format, has been generated by the Skype application, these two applications being executed by the browser at the instant considered.

According to a second step, the device consults a database such as mentioned hereinabove, i.e. indicating which applications are the ones that must form the subject of a marking, and which are the application/marking value pairs. It will be noted that this database can be contained in the terminal hosting the device, or in an external module linked to said terminal.

Finally, according to a third step, the data packets that the device sends are marked accordingly by the latter. This marking (denoted DSCP X, DSCP Y, and so on and so forth, in FIG. 1) is therefore representative of the QoS level associated with each application (denoted Web App ID X, Web App ID Y, and so on and so forth) in accordance with the enterprise policy.

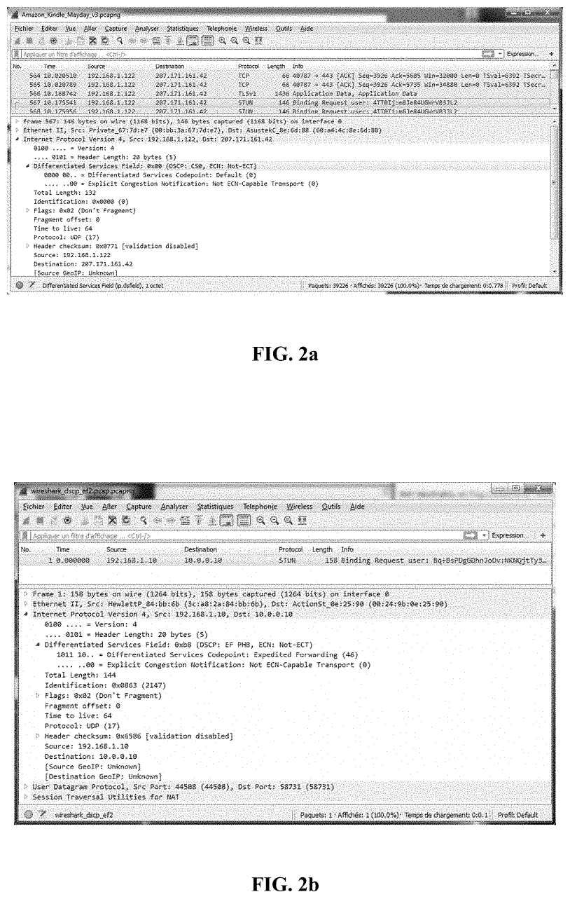

FIGS. 2a and 2b represent, as output of a Web browser, a list of interactive real-time streams which is obtained with a network analysis tool, such as Wireshark.

FIG. 2a corresponds to the case where said streams are generated by an unprioritized application. It is seen that the value of the “Differentiated Services Code Point” field is set to “Default”. These streams will therefore be processed by the enterprise's routers with a default QoS level.

FIG. 2b corresponds to the case where said streams are generated by a prioritized application. It is seen that the value of the “Differentiated Services Code Point” field is set to “Expedited Forwarding”. These streams will therefore benefit from fast transfer at the level of the routers of the enterprise.

It will be noted, finally, that the invention can be implemented within Web browsers of personal computers, operating systems of mobile terminals or connected objects, by means of software components and/or hardware components.

The software components will be able to be integrated into a conventional computer program for network node management. This is why, as indicated hereinabove, the present invention also relates to a computer system. This computer system comprises in a conventional manner a central processing unit controlling by signals a memory, as well as an input unit and an output unit. Moreover, this computer system can be used to execute a computer program comprising instructions for managing the operation of a multimedia stream marking device according to the invention.

Indeed, the invention is also aimed at a computer program downloadable from a communication network comprising instructions for managing the operation of a multimedia stream marking device according to the invention, when it is executed on a computer. This computer program can be stored on a medium readable by computer and can be executable by a microprocessor.

This program can use any programming language, and take the form of source code, object code, or of code intermediate between source code and object code, such as in a partially compiled form, or in any other desirable form.

The invention is also aimed at an irremovable, or partially or totally removable, information medium readable by a computer, and comprising instructions of a computer program such as is mentioned hereinabove.

The information medium can be any entity or device capable of storing the program. For example, the medium can comprise a storage means, such as a ROM, for example a CD ROM or a microelectronic circuit ROM, or a magnetic recording means, such as a hard disk, or else a USB key (“USB flash drive” in English).

Moreover, the information medium can be a transmissible medium such as an electrical or optical signal, which can be conveyed via an electrical or optical cable, by radio or by other means. The computer program according to the invention can in particular be downloaded over a network of Internet type.

As a variant, the information medium can be an integrated circuit into which the program is incorporated, the circuit being adapted to execute or to be used with the aim of managing the operation of a multimedia stream marking device according to the invention.

Although the present disclosure has been described with reference to one or more examples, workers skilled in the art will recognize that changes may be made in form and detail without departing from the scope of the disclosure and/or the appended claims.

1. A multimedia stream marking device, comprising:
a processor; and
a non-transitory computer-readable medium comprising instructions stored thereon, which when executed by the processor configure the multimedia stream marking device to perform acts comprising:
subsequently to receiving a multimedia stream generated by a computer application executed by said device, identifying said computer application by using an application identifier,
consulting a database indicating which computer applications are the ones that must form the subject of a marking and which are computer application/marking value pairs, and
conditioning the multimedia stream in the form of data packets marked accordingly.

2. The multimedia stream marking device as claimed in claim 1, wherein said marking uses the DSCP (Differentiated Services Code Point) standard.

3. The multimedia stream marking device as claimed in claim 1, the device is embedded in a Web browser.

4. The multimedia stream marking device as claimed in claim 1 the device is embedded in the operating system of a mobile terminal.

5. The multimedia stream marking device as claimed in claim 1 the device is embedded in a connected object.

6. A system for hierarchizing computer applications which are implemented by a group of users, comprising:
a multimedia stream marking device, comprising:
a processor; and
a non-transitory computer-readable medium comprising instructions stored thereon, which when executed by the processor configure the multimedia stream marking device to perform acts comprising:
subsequently to receiving a multimedia stream generated by a computer application executed by said device, identifying said computer application by using an application identifier,
consulting a database indicating which computer applications are the ones that must form the subject of a marking and which are computer application/marking value pairs, and
conditioning the multimedia stream in the form of data packets marked accordingly, and
at least one router able to take said marking into account so as to apply to multimedia streams traveling through said router service levels differentiated as a function of the computer applications generating these multimedia streams.

7. A non-transitory, irremovable, or partially or totally removable computer-readable medium for storing data, comprising computer program code instructions for managing operation of a multimedia stream marking device when executed by a processor of the device, wherein the instructions configure the device to:
subsequently to receiving a multimedia stream generated by a computer application executed by said device, identifying said computer application by using an application identifier,
consulting a database indicating which computer applications are the ones that must form the subject of a marking and which are computer application/marking value pairs, and
conditioning the multimedia stream in the form of data packets marked accordingly.

8. (canceled)

9. A multimedia stream marking method, comprising:
receiving a multimedia stream generated by a computer application executed by a multimedia stream marking device,
identifying said computer application by using an application identifier,
consulting a database indicating which applications are the ones that must form the subject of a marking, and which are the computer application/marking value pairs, and
conditioning of the multimedia stream by said multimedia stream marking device in the form of data packets marked accordingly.

10. The multimedia stream marking method as claimed in claim 9, wherein said marking uses the DSCP (Differentiated Services Code Point) standard.

11. The multimedia stream marking device as claimed in claim 1, wherein the device embedded in a terminal.
